(19) United States
(12) Patent Application Publication
(10) Pub. No.: US 2013/0222206 A1
(43) Pub. Date: Aug. 29, 2013

(54) MULTIBAND PORTABLE TERMINAL AND METHOD FOR CONTROLLING THEREOF

(71) Applicant: Pantech Co., Ltd., (US)

(72) Inventor: Won Seok PARK, Seoul (KR)

(73) Assignee: Pantech Co., Ltd., Seoul (KR)

(21) Appl. No.: 13/780,568

(22) Filed: Feb. 28, 2013

(30) Foreign Application Priority Data
Feb. 29, 2012 (KR) 10-2012-0020997

(51) Int. Cl. H01Q 5/00; H01Q 1/50

(52) U.S. Cl. CPC H01Q 5/001; H01Q 1/50
USPC 343/876; 343/893

(57) ABSTRACT

A portable terminal includes a first antenna unit including a low-frequency band antenna to service a low-frequency band; a second antenna unit including a high-frequency band antenna to service a high-frequency band; a first sub-antenna to support the low-frequency band antenna during communication; and a second sub-antenna to support the high-frequency band antenna during communication. A portable terminal includes a first antenna unit including a low-frequency band antenna to service a low-frequency band; a second antenna unit including a high-frequency band antenna to service a high-frequency band, in which the first antenna unit is disposed at a first portion of the portable terminal and the second antenna unit is disposed at a second portion of the portable terminal.

### CROSS-REFERENCE TO RELATED APPLICATION

This application claims priority from and the benefit of Korean Patent Application No. 10-2012-0020997, filed on Feb. 29, 2012, which is hereby incorporated by reference for all purposes as if fully set forth herein.

### BACKGROUND

1. Field

Exemplary embodiments of the present invention relate to a configuration of an embedded antenna of a portable terminal, and a switch control algorithm for an antenna having a switch structure.

2. Discussion of the Background

Among embedded antennas of a portable terminal, to implement a full-screen portable terminal with a structure that supports Long Term Evolution (LTE), the size of bezels may be reduced horizontally (x-axis) and vertically (y-axis). Further, for the same portable terminal to support a Liquid Crystal Display (LCD) screen on a large area of a terminal with a full size screen, a structure of the terminal in which the LCD screen may overlap with an antenna based on a z-axis may be incurred.

Since an LCD chassis screen may include a screen that may be in contact with a ground (GND) of a terminal, a structure with an area in which a ground surface may overlap a feeder and a radiator of an antenna may be formed.

The above structure may have a characteristic of a narrow band that may be narrower than a bandwidth attainable by an antenna, which may be associated with a reduction in performance or an attribute of the antenna. Additionally, if a hand grasps a terminal with the structure in which the ground surface may overlap a reference portion of the antenna, a resonant frequency of the antenna may be moved or affected due, at least in part, to an influence of an approach of the hand or a dielectric medium. More particularly, the resonant frequency of the antenna may be moved a longer distance than a resonant frequency of an antenna of a terminal that may maintain a sufficient distance with a ground surface, which may be associated with a reduction in performance or an attribute of an antenna of a full screen terminal.

Accordingly, there may be a need to ensure at least a non-ground area in the portable terminal to secure performance of an antenna or reduce a likelihood of reduction in performance of an antenna. However, due, at least in part, to the non-ground area, a structure of the portable terminal may become damaged or modified to become undesirable by a consumer.

To solve the above described problems, various attempts have been made. Additionally, various researches on a tunable antenna and a switching antenna have been conducted. However, there may be many difficulties to satisfy both a structure of a full screen and a characteristic of an antenna when the terminal is grasped.

### SUMMARY

Exemplary embodiments of the present invention provide a configuration of an embedded antenna of a portable terminal, and a switch control algorithm for an antenna having a switch structure.

Additional features of the invention will be set forth in the description which follows, and in part will be apparent from the description, or may be learned by practice of the invention.

Exemplary embodiments of the present invention provide a portable terminal including a first antenna unit including a low-frequency band antenna to service a low-frequency band; a second antenna unit including a high-frequency band antenna to service a high-frequency band; a first sub-antenna unit to support the low-frequency band antenna during communication; and a second sub-antenna to support the high-frequency band antenna during communication.

Exemplary embodiments of the present invention provide a portable terminal including a first antenna unit including a low-frequency band antenna to service a low-frequency band; a second antenna unit including a high-frequency band antenna to service a high-frequency band, in which the first antenna unit is disposed at a first portion of the portable terminal and the second antenna unit is disposed at a second portion of the portable terminal.

Exemplary embodiments of the present invention provide a portable terminal including a first antenna unit including a low-frequency band antenna to service a low-frequency band; a second antenna unit including a high-frequency band antenna to service a high-frequency band; a sensor to detect an approach of a dielectric medium and to determine whether a part of the first antenna unit or the second antenna unit is affected by the dielectric medium; and a compensation controller to determine a permittivity of at least one of the low-frequency band antenna and the high-frequency band antenna affected by the dielectric medium using sensing information of the sensor, and to determine a compensation value of a resonant frequency of at least one of the low-frequency band antenna and the high-frequency band antenna that is changed in response to the dielectric medium, the compensation value corresponding to the permittivity.

Exemplary embodiments of the present invention provide a portable terminal including a first antenna unit including a first main antenna to service a first frequency band, and a first sub antenna to service a second frequency band; a second antenna unit including a second main antenna to service the second frequency band and a second sub antenna to service the first frequency band; a communication unit to select an antenna to transmit or receive a radio signal including data; a first switch unit to switch the radio signal from the first frequency band antenna to the selected antenna; and a second switch unit to switch the radio signal from the second frequency band antenna to the selected antenna.

Exemplary embodiments of the present invention provide a method for compensating for a change in permittivity including determining permittivity of at least one of a low-frequency band antenna and a high-frequency band antenna of a portable terminal; and determining a compensation value of a resonant frequency of at least one of the low-frequency band antenna and the high-frequency band antenna that is changed, in which the compensation value corresponds to the permittivity.

Exemplary embodiments of the present invention provide a method for switching antennas in a portable terminal including selecting an antenna for transmitting or receiving a radio signal including data; switching the radio signal from a first frequency band antenna of a portable terminal to the selected antenna; and switching the radio signal from a second frequency band antenna of the portable terminal to the selected antenna.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a graph illustrating a movement of a resonant frequency to be generated if an antenna approaches a ground surface according to an exemplary embodiment of the present invention.

FIG. 2 is a graph illustrating an increase and a reduction in sharpness of a resonant frequency to be generated when an antenna approaches a ground surface according to an exemplary embodiment of the present invention.

FIG. 3 is a diagram illustrating a portable terminal with a multiband antenna according to an exemplary embodiment of the present invention.

FIG. 4 is a block diagram illustrating a configuration of a portable terminal with a multiband antenna according to an exemplary embodiment of the present invention.

FIG. 5A and FIG. 5B are diagrams illustrating a configuration of antennas in a portable terminal according to an exemplary embodiment of the present invention.

FIG. 6 is a diagram illustrating a portable terminal with a multiband antenna and sensors according to an exemplary embodiment of the present invention.

FIG. 7 is a block diagram illustrating a configuration of a portable terminal with a multiband antenna and sensors according to an exemplary embodiment of the present invention.

FIG. 8A and FIG. 8B are diagrams illustrating a configuration of antennas of a portable terminal according to an exemplary embodiment of the present invention.

FIG. 9 is a flowchart illustrating an operation of compensating for a resonant frequency based on a permittivity according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

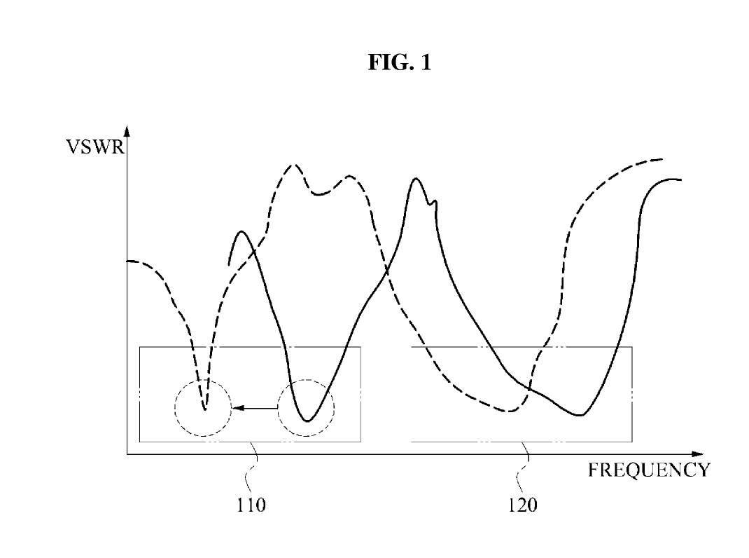

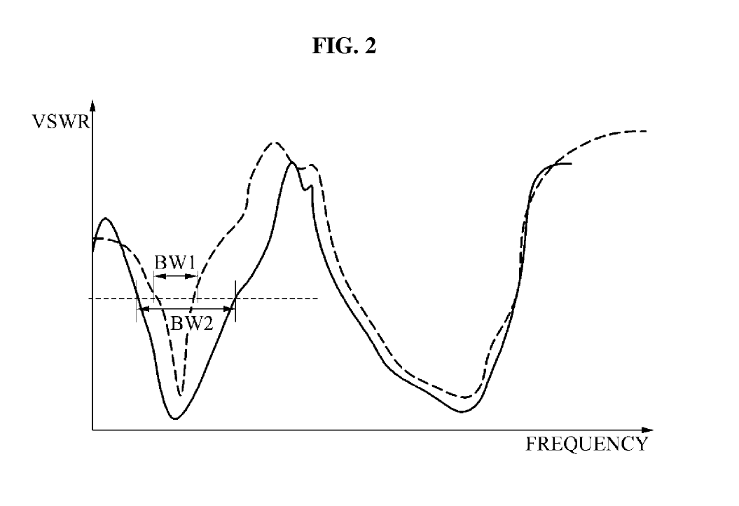

Hereinafter, characteristics for one or more frequencies generated when an antenna approaches a ground surface will be described below. The approach of the dielectric medium may include, but not limited to, a contact of the terminal, or locating to a reference proximity to the terminal, in which the terminal is affected by the dielectric medium. A characteristic of a Voltage Standing Wave Ratio (VSWR) for each frequency when an antenna approaches a ground surface is shown in FIG. 1 and FIG. 2.

FIG. 1 is a graph illustrating a movement of a resonant frequency to be generated when an antenna approaches a ground surface according to an exemplary embodiment of the present invention.

Referring to FIG. 1, when a dielectric medium is in contact with the ground surface, which may be due to grasping of a terminal or the like, a resonant frequency indicated by a solid line may be moved to a resonant frequency indicated by a dotted line. In this instance, a resonant frequency of a low-frequency band 110 may move a longer distance than a resonant frequency of a high-frequency band 120.

FIG. 2 is a graph illustrating an increase and a reduction in sharpness of a resonant frequency to be generated when an antenna approaches a ground surface according to an exemplary embodiment of the present invention.

Referring to FIG. 2, when a dielectric medium is in contact with the ground surface, which may be due to grasping of a terminal or the like, a resonant frequency indicated by a solid line may be reduced from a second bandwidth (BW2) to a resonant frequency a first bandwidth (BW1) indicated by a dotted line. In this instance, a resonant frequency of a low-frequency band may be further reduced than a resonant frequency of a high-frequency band.

More specifically, as shown in FIG. 1 and FIG. 2, a low-frequency band may be determined to be more sensitive to contact with the ground surface compared to a high-frequency band. Accordingly, an antenna of the low-frequency band may be disposed in a portion of a portable terminal that may be less likely to be in contact with the dielectric medium. In an example, the ground surface may include a ground plane or the like.

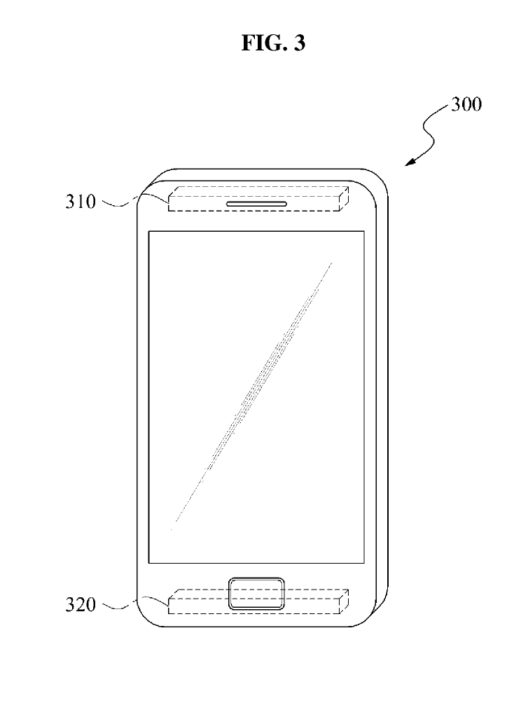

Since the low-frequency band may be more sensitive to a contact with the dielectric medium, a multiband antenna may be disposed in a portable terminal, as shown in FIG. 3.

FIG. 3 is a diagram illustrating a portable terminal equipped with a multiband antenna according to an exemplary embodiment of the present invention.

Referring to FIG. 3, a portable terminal 300 may include a first antenna unit 310, and a second antenna unit 320.

The first antenna unit 310 may be disposed at an upper portion of the portable terminal 300 that may be less likely to be in contact with a dielectric medium, and the second antenna unit 320 may be disposed at a lower portion of the portable terminal 300. In this instance, the first antenna unit 310 may include at least one low-frequency band antenna that may have reference sensitivity. Additionally, the second antenna unit 320 may include at least one high-frequency band antenna that may be less sensitive than the low-frequency band antenna in the first antenna unit 310, i.e., the sensitivity of the second antenna unit 320 may be less than the reference sensitivity of the first antenna unit 310.

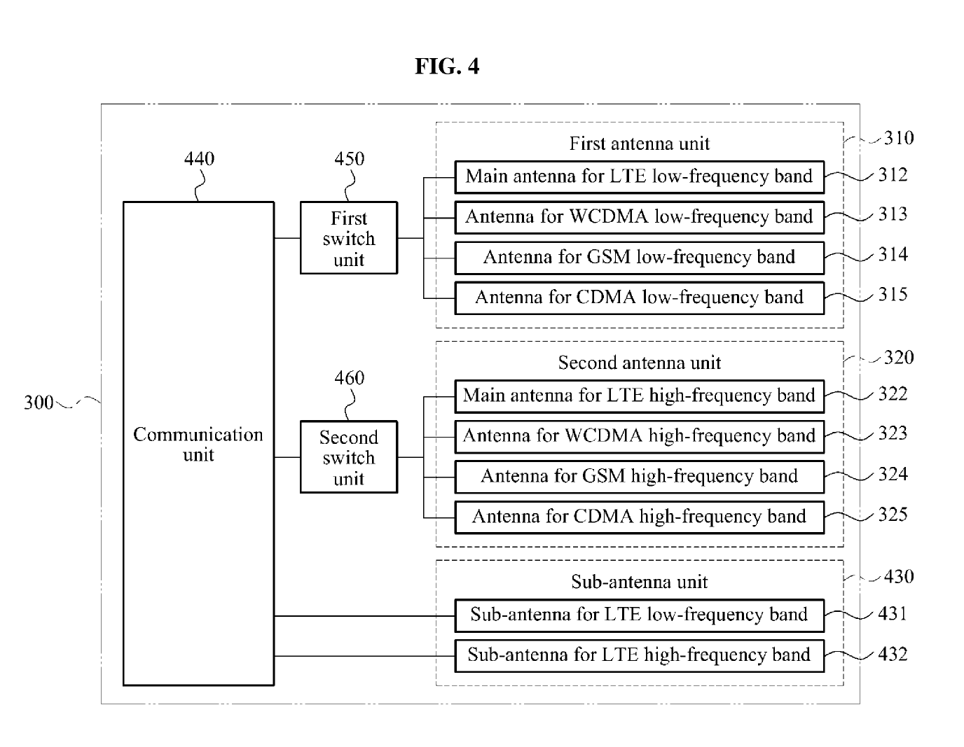

FIG. 4 is a block diagram illustrating a configuration of a portable terminal with a multiband antenna according to an exemplary embodiment of the present invention.

Referring to FIG. 4, a portable terminal 300 may include a first antenna unit 310, a second antenna unit 320, a sub-antenna unit 430, a communication unit 440, a first switch unit 450, and a second switch unit 460.

The first antenna unit 310 may include at least one low-frequency band antenna. The low-frequency band antenna may include at least one of a main antenna 312 to service a Long Term Evolution (LTE) low-frequency band, an antenna 313 to service a Wideband Code Division Multiple Access (WCDMA) low-frequency band, an antenna 314 to service a Global System for Mobile communications (GSM) low-frequency band, and an antenna 315 to service a Code Division Multiple Access (CDMA) low-frequency band.

The second antenna unit 320 may include at least one high-frequency band antenna. The high-frequency band antenna may include at least one of a main antenna 322 to service an LTE high-frequency band, an antenna 323 to service a WCDMA high-frequency band, an antenna 324 to service a GSM high-frequency band, and an antenna 325 to service a CDMA high-frequency band.

The sub-antenna unit 430 may include at least one sub-antenna to support an antenna included in either the first antenna unit 310 or the second antenna unit 320 during communication. The sub-antenna unit 430 may include at least one of a sub-antenna 431 to service the LTE low-frequency band, and a sub-antenna 432 to service the LTE high-frequency band. However, the sub-antennas are not limited to servicing the LTE bands; for example, the sub-antenna unit 430 may also service a CDMA band, GSM band, the WCDMA band or the like.

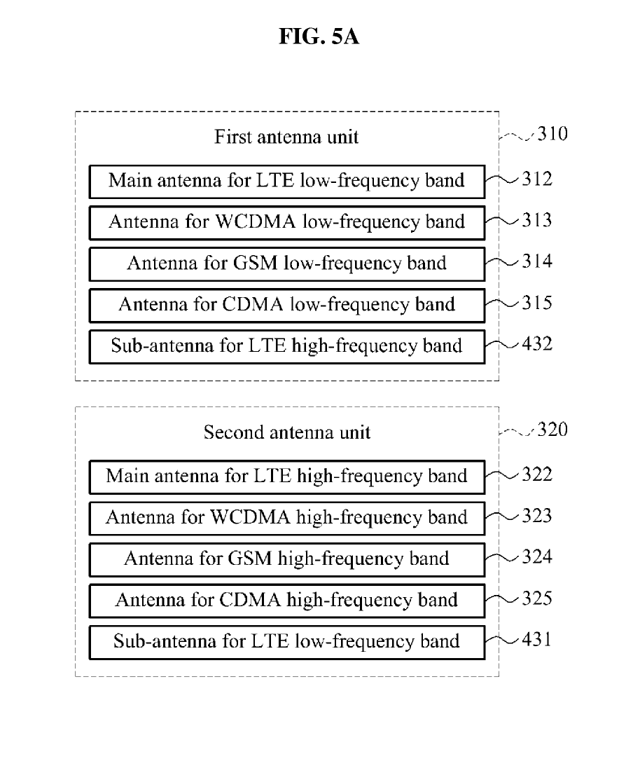

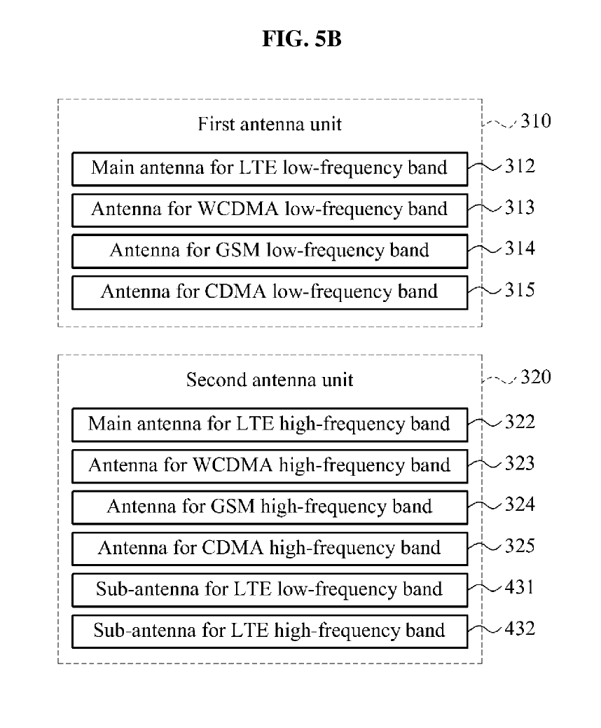

The sub-antenna 431 and the sub-antenna 432 in the sub-antenna unit 430 may be included in the first antenna unit 310, the second antenna unit 320, or both, as shown in FIG. 5A and FIG. 5B.

FIG. 5A and FIG. 5B are diagrams illustrating configurations of antennas in the portable terminal 300 of FIG. 4.

FIG. 5A illustrates an example in which the sub-antenna 431 and the sub-antenna 432 in the sub-antenna unit 430 are included in antenna units that may service different frequency bands from main antennas included therein. In an example, the main antenna may be able to operate any one of the LTE, WCDMA, CDMA, and GSM bands. Further, although not illustrated, there may be more than one main antenna per antenna unit, and more than one main antenna per band type. More specifically, referring to FIG. 5A, the sub-antenna 431, which may service a low-frequency band, may be included in the second antenna unit 320, which may include a set of high-frequency band antennas, and the sub-antenna 432, which may service a high-frequency band, may be included in the first antenna unit 310, which may include a set of low-frequency band antennas.

FIG. 5B illustrates an example in which both the sub-antenna 431 and the sub-antenna 432 are included in the second antenna unit 320.

Additionally, each of the sub-antenna 431 and the sub-antenna 432 may be included in the first antenna unit 310 and/or the second antenna unit 320. The sub-antenna 431 and the sub-antenna 432 may be included in either the first antenna unit 310 or the second antenna unit 320. In an example, the sub-antennas included in the sub-antenna unit 430 may service different frequency bands from the main antennas included the respective antenna units but having the same communication band. However, the sub-antenna 431 and the sub-antenna 432 may be included in the same antenna units with the main antennas.

The communication unit 440 may select an antenna to be used for communication based on a type of communication to be serviced, and may transmit or receive a radio signal of data that may inputted or outputted via the selected antenna. To transmit the radio signal, the communication unit 440 may perform channel coding and spreading on data to be transmitted, perform Radio Frequency (RF) processing on the data, and transmit the data using a RF radio signal. To receive the radio signal, the communication unit 440 may convert a received RF signal to a baseband signal, perform de-spreading and channel decoding on the baseband signal, and restore the data that was included in the received RF radio signal.

If either the main antenna 312 or the main antenna 322 is selected, the communication unit 440 may select a corresponding sub-antenna from the sub-antenna unit 430 to support communication. The selected main antenna may use the selected sub-antenna during the communication. More specifically, the sub-antenna in the same frequency band as the selected main antenna may be used. In an example, if the main antenna 312 is selected to receive low-frequency band signals, corresponding sub-antenna from the sub-antenna unit 430 may be selected to accommodate low-frequency band signals that may be received during communication. However, aspects of the invention are not limited thereto.

The first switch unit 450 may switch the radio signal to an antenna selected by the communication unit 440 from among low-frequency band antennas that may be included in the first antenna unit 310.

The second switch unit 460 may switch the radio signal to an antenna selected by the communication unit 440 from among high-frequency band antennas that may be included in the second antenna unit 320.

The first switch unit 450 may be separated from the second switch unit 460 to be located in reference proximity to each of the first antenna unit 310 and the second antenna unit 320, because the first antenna unit 310 and the second antenna unit 320 may physically be separated and disposed in an upper portion and a lower portion of the portable terminal 300. In an example, the first switch unit 450 may be separated from the second switch unit 460 to enable a switch that may request to switch an antenna.

Additionally, if a main antenna for LTE and a sub-antenna for LTE are separately included in the first antenna unit 310 and the second antenna unit 320, respectively, the first switch unit 450 and the second switch unit 460 may be separated from each other. The first switch unit 450 and the second switch unit 460 may be separated from each other to switch a radio signal to the main antenna for LTE or the sub-antenna for LTE included in the first antenna unit 310 or the second antenna unit 320. For example, as shown in FIG. 5A, if an LTE low-frequency band is used as a communication band, two switches may be used to perform communication using both the main antenna 312 and the sub-antenna 431.

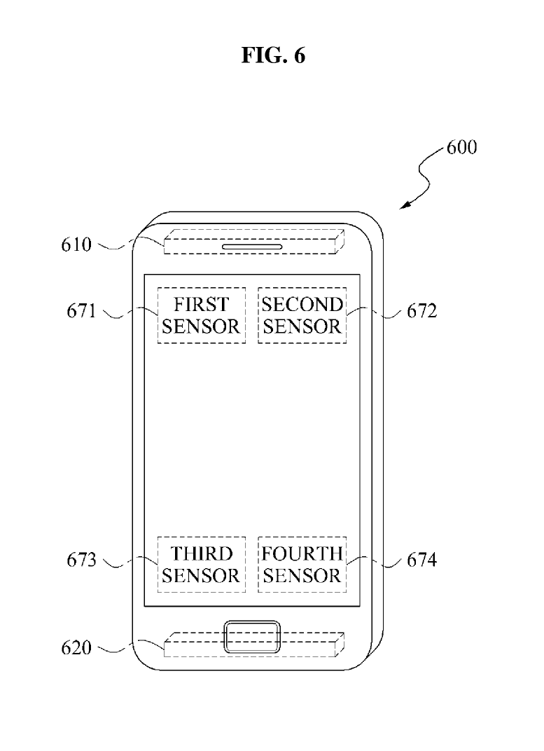

FIG. 6 is a diagram illustrating a portable terminal with a multiband antenna and sensors according to an exemplary embodiment of the present invention.

Referring to FIG. 6, a portable terminal 600 may include a first antenna unit 610, a second antenna unit 620, a first sensor 671, a second sensor 672, a third sensor 673, and a fourth sensor 674.

The first antenna unit 610 may be disposed in an upper portion of the portable terminal 600 that may be less likely to be in contact with a dielectric medium. The second antenna unit 620 that may be disposed in a lower portion of the portable terminal 600. The first antenna unit 610 may include at least one low-frequency band antenna that may be more sensitive than a high-frequency band antenna. Additionally, the second antenna unit 620 may include at least one high-frequency band antenna that may be less sensitive than the at least one low-frequency band antenna in the first antenna unit 610.

The first sensor 671 and the second sensor 672 may be used to determine whether a part of the first antenna unit 610 is being grasped. The third sensor 673 and the fourth sensor 674 may be used to determine whether a part of the second antenna unit 620 is being grasped.

In FIG. 6, four sensors, namely the first sensor 671, the second sensor 672, the third sensor 673, and the fourth sensor 674 may be used to detect an approach of the dielectric medium, but there is no limitation thereto. Accordingly, a single or multiple sensors may be used. In other words, at least one sensor may be included.

The first sensor 671, the second sensor 672, the third sensor 673, and the fourth sensor 674 may include at least one of a proximity detection sensor, a capacitive touch sensor, and the like. The capacitive touch sensor may detect the approach of the dielectric medium, and may be suitable for the first sensor 671, the second sensor 672, the third sensor 673, and the fourth sensor 674. Sensing operations of the first sensor 671, the second sensor 672, the third sensor 673, and the fourth sensor 674, and processing of sensing information may be well-known in the art, and accordingly further description thereof will be omitted.

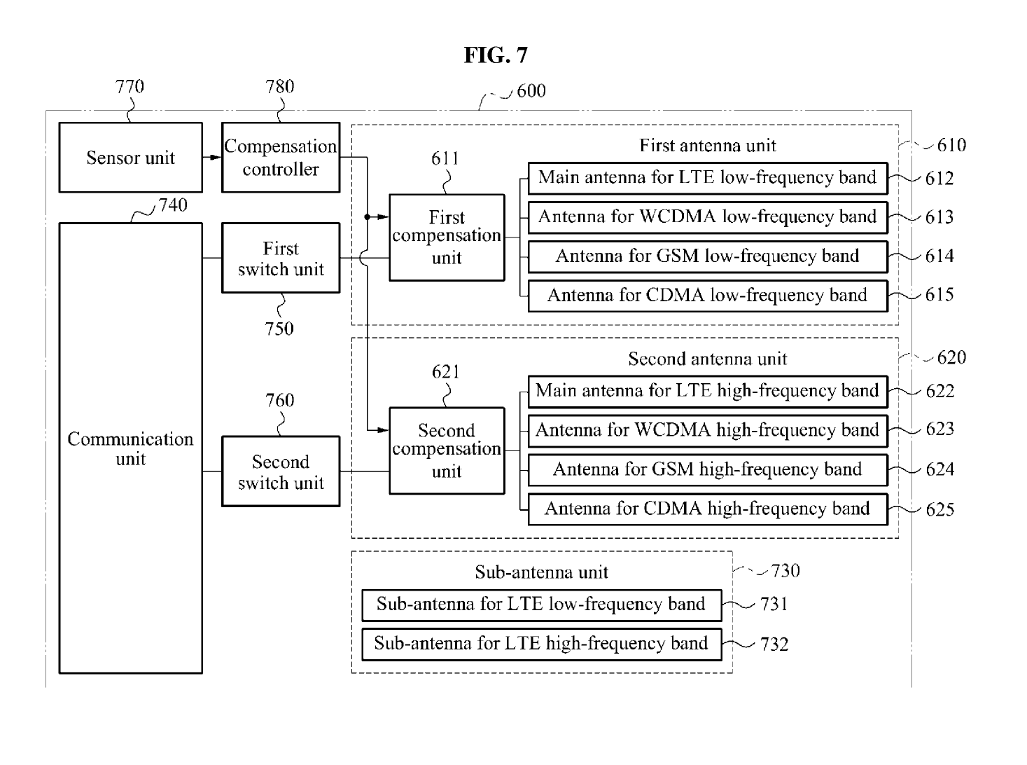

FIG. 7 is a block diagram illustrating a configuration of a portable terminal with a multiband antenna and sensors according to an exemplary embodiment of the present invention.

Referring to FIG. 7, a portable terminal 600 may include a first antenna unit 610, a second antenna unit 620, a sub-antenna unit 730, a communication unit 740, a first switch unit 750, a second switch unit 760, a sensor unit 770, and a compensation controller 780.

The first antenna unit 610 may include a first compensation unit 611, and at least one low-frequency band antenna. The low-frequency band antenna may include at least one of a main antenna 612 for an LTE low-frequency band, an antenna 613 for a WCDMA low-frequency band, an antenna 614 for a GSM low-frequency band, and an antenna 615 for a CDMA low-frequency band.

The second antenna unit 620 may include a second compensation unit 621, and at least one high-frequency band antenna. The high-frequency band antenna may include a main antenna 622 for an LTE high-frequency band, an antenna 623 for a WCDMA high-frequency band, an antenna 624 for a GSM high-frequency band, or an antenna 625 for a CDMA high-frequency band.

The first compensation unit 611 and the second compensation unit 621 will be described in more detail after the compensation controller 780 is described.

The sub-antenna unit 730 may include at least one sub-antenna to support an antenna included in the first antenna unit 610 or the second antenna unit 620 during communication. The sub-antenna unit 730 may include at least one of a sub-antenna 731 for the LTE low-frequency band, and a sub-antenna 732 for the LTE high-frequency band. Further, the communication unit 740 may be connected to the sub-antenna unit 730, which may be controlled by the communication unit 740.

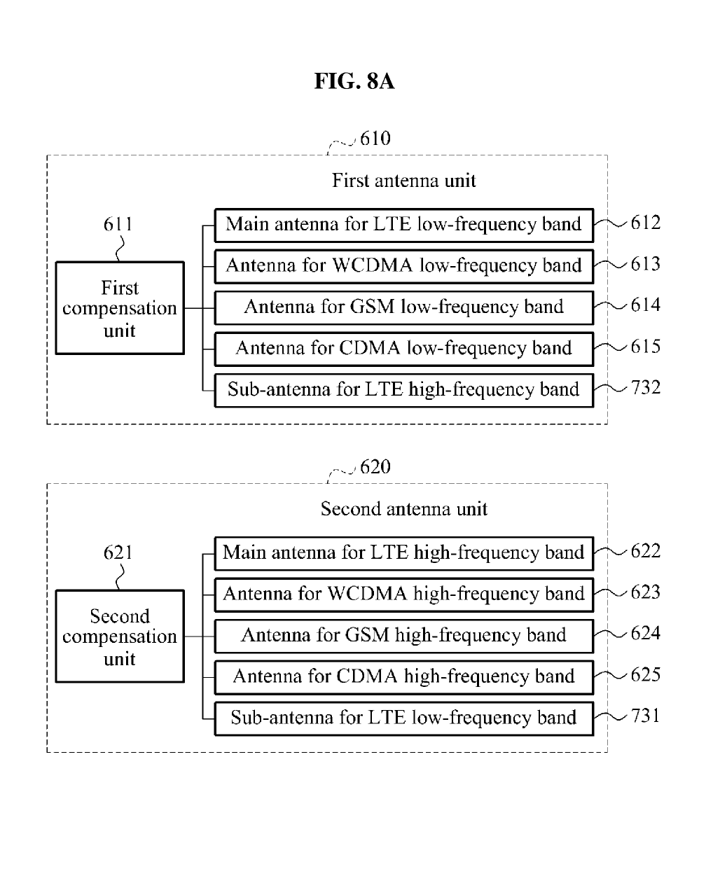

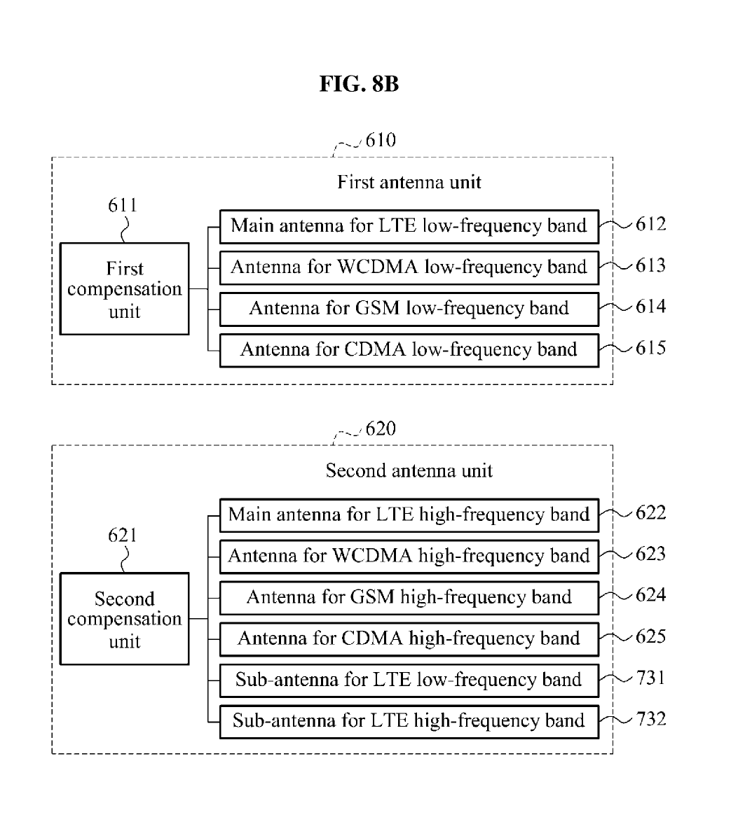

The sub-antenna 731 and the sub-antenna 732 in the sub-antenna unit 730 may be included in the first antenna unit 610, the second antenna unit 620, or both, as shown in FIG. 8A and FIG. 8B.

FIG. 8A and FIG. 8B are diagrams illustrating arrangement configuration of antennas of a portable terminal 600 according to an exemplary embodiment of the present invention.

FIG. 8A illustrates an example in which the sub-antenna 731 and the sub-antenna 732 in the sub-antenna unit 730 are included in antenna units that may service different frequency bands from main antennas included therein. Referring to FIG. 8A, the sub-antenna 731, which may service a low-frequency band, may be included in the second antenna unit 620 that may include a set of high-frequency band antennas, and the sub-antenna 732, which may service a high-frequency band, may be included in the first antenna unit 610 that may include a set of low-frequency band antennas.

FIG. 8B illustrates an example in which both the sub-antenna 731 and the sub-antenna 732 are included in the second antenna unit 620.

Each of the sub-antenna 731 and the sub-antenna 732 may be included in the first antenna unit 610 or the second antenna unit 620. In this instance, the sub-antenna 731, which may service a low-frequency band, and the sub-antenna 732, which may service a high-frequency band, may be included in the second antenna unit 620 that includes main antennas that service a high-frequency band. However, the sub-antennas may be included in the same antenna unit as the main antennas in the respective antenna unit.

The communication unit 740 may select an antenna to be used for communication based on a type of communication to be serviced, and may transmit or receive a radio signal of data that may be inputted or outputted via the selected antenna. To transmit the radio signal, the communication unit 740 may perform channel coding and spreading on data to be transmitted, perform RF processing on the data, and transmit the data using a radio signal. To receive the radio signal, the communication unit 440 may convert a received RF signal to a baseband signal, perform de-spreading and channel decoding on the baseband signal, and restore the data that was included in the received radio signal.

If either the main antenna 612 or the main antenna 622 is selected, the communication unit 740 may select a corresponding sub-antenna from the sub-antenna unit 730 to support communication. The selected main antenna may use the selected sub-antenna during the communication.

The first switch unit 750 may switch the radio signal to an antenna selected by the communication unit 740 from among low-frequency band antennas that may be included in the first antenna unit 610.

The second switch unit 760 may switch the radio signal to an antenna selected by the communication unit 740 from among high-frequency band antennas that may be included in the second antenna unit 620.

The first switch unit 750 may be separated from the second switch unit 760 to be located in reference proximity to each of the first antenna unit 610 and the second antenna unit 620, because the first antenna unit 610 and the second antenna unit 620 may physically be separated and disposed in an upper portion and a lower portion of the portable terminal 600.

Additionally, if a main antenna for LTE and a sub-antenna for LTE are separately included in the first antenna unit 610 and the second antenna unit 620, respectively, the first switch unit 750 and the second switch unit 760 may be separated from each other. The first switch unit 750 and the second switch unit 760 may be separated from each other to switch a radio signal to the main antenna for LTE or the sub-antenna for LTE included in the first antenna unit 610 or the second antenna unit 620. For example, as shown in FIG. 8A, if an LTE low-frequency band is used as a communication band, two switches may be used to perform communication using both the main antenna 612 and the sub-antenna 731.

The sensor unit 770 may include at least one sensor to detect a portion and a range of distance of the portable terminal 600 in which a dielectric medium may approach or may be in contact with the portable terminal 600. The sensor unit 770 may include a single sensor or a plurality of sensors, for example the first sensor 671, the second sensor 672, the third sensor 673, and the fourth sensor 674 of FIG. 6, to accurately detect an approach of the dielectric medium or a contact with the dielectric medium in some or all portions of the portable terminal 600.

The compensation controller 780 may verify or determine permittivity that may be associated with the dielectric medium using sensing information of the at least one sensor in the sensor unit 770. More specifically, the compensation controller 780 may determine a permittivity of at least one of the low-frequency band antenna and the high-frequency band antenna affected by the dielectric medium using sensing information of the at least one sensor in the sensor unit 770. Further, the compensation controller 780 may verify or determine a compensation value of a resonant frequency corresponding to the permittivity for at least one of the low-frequency band antenna in the first antenna unit 610 and the high-frequency band antenna in the second antenna unit 620. The compensation controller 780 may search for a compensation table, and may verify a compensation value corresponding to the permittivity. The compensation table may include a list of compensation values of a resonant frequency that may correspond to a list of permittivity for at least one of the low-frequency band antennas and the high-frequency band antennas may be set in advance and stored.

The first compensation unit 611 may compensate for a resonant frequency of a radio signal serviced by at least one of the low-frequency band antenna using the compensation value verified or determined by the compensation controller 780. More specifically, the first compensation unit 611 may compensate by moving or modifying the resonant frequency so that the resonant frequency may be similar to a resonant frequency of a radio signal in which permittivity may not be verified or determined. The radio signal may be transmitted or received via an antenna selected by the communication unit 740 from among the low-frequency band antennas that may be included in the first antenna unit 610.

The second compensation unit 621 may compensate for a resonant frequency of a radio signal serviced by at least one of the high-frequency band antenna, using the compensation value verified by the compensation controller 780. More specifically, the second compensation unit 621 may compensate by moving or modifying the resonant frequency so that the resonant frequency may be similar to a resonant frequency of a radio signal in which permittivity may not be verified or determined. The radio signal may be transmitted or received via an antenna selected by the communication unit 740 from among the high-frequency band antennas that may be included in the second antenna unit 620. If the at least one high-frequency band in the second antenna unit 620 is less changed by the permittivity than the first antenna unit 610, the second compensation unit 621 may be removed from the portable terminal 600. However, aspects of the invention are not limited thereto, such that the second compensation unit 621 may be included but deactivated if the at least one high-frequency band in the second antenna unit 620 is less changed by the permittivity than the first antenna unit 610.

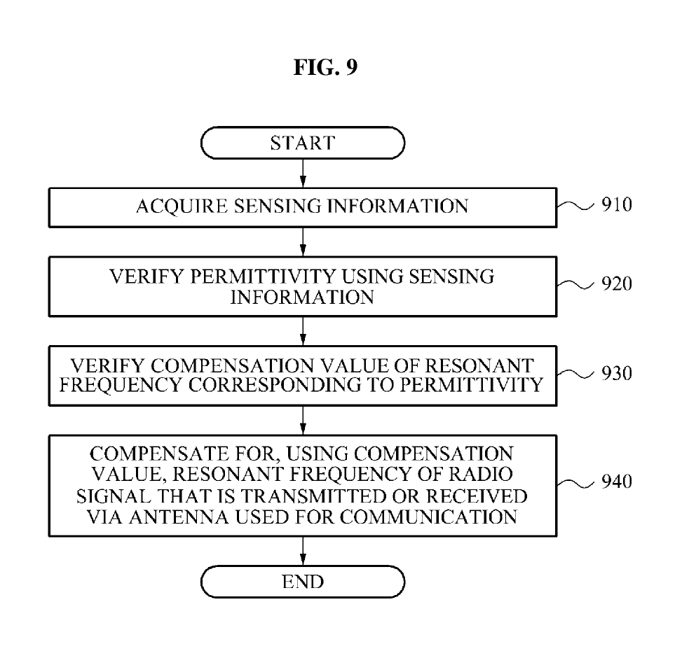

Hereinafter, a method of controlling a portable terminal with a multiband antenna according to an exemplary embodiment of the present invention will be described with reference to FIG. 9.

FIG. 9 is a flowchart illustrating an operation of compensating for a resonant frequency based on a permittivity according to an exemplary embodiment of the present invention.

Referring to FIG. 9, in operation 910, the portable terminal may detect, using at least one sensor, a portion and a range of the portable terminals in which a dielectric medium may approach or may be in contact with the portable terminal.

In operation 920, the portable terminal may verify or determine a permittivity associated with the dielectric medium, using sensing information of the at least one sensor.

In operation 930, the portable terminal may verify or determine a compensation value of a resonant frequency corresponding to permittivity of an antenna used for communication among antennas included in a first antenna unit and a second antenna unit. Further, the portable terminal may search for a compensation table, and may verify or determine a compensation value corresponding to the permittivity. A compensation value of resonant frequency corresponding to the permittivity of one or more of the antennas included in the first antenna unit and the second antenna unit may be set in advance and stored in the compensation table.

In operation 940, the portable terminal may compensate for, using the verified compensation value, a resonant frequency of a radio signal that may be transmitted or received via the antenna used for communication.

According to exemplary embodiments of the present invention, it may be possible to improve a performance of a multiband antenna by separating a high-frequency band antenna from a low-frequency band antenna, disposing the low-frequency band antenna with a reference sensitivity to a change in permittivity in an upper portion of a portable terminal, and disposing the high-frequency band antenna in a lower portion of the portable terminal. Further, it may be possible to improve a performance of an antenna by compensating for a resonant frequency of the antenna based on a change in permittivity that may be associated with grasping of the portable terminal.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of exemplary embodiments of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A portable terminal, comprising:
a first antenna unit comprising a low-frequency band antenna to service a low-frequency band;
a second antenna unit comprising a high-frequency band antenna to service a high-frequency band;
a first sub-antenna to support the low-frequency band antenna during communication; and
a second sub-antenna to support the high-frequency band antenna during communication.

2. The portable terminal of claim 1, further comprising:
a sensor to detect an approach of a dielectric medium and to determine whether a part of the first antenna unit or the second antenna unit is affected by the dielectric medium.

3. The portable terminal of claim 2, wherein the sensor comprises at least one of a proximity detection sensor to determine a range of the portable terminal to the dielectric medium, and a capacitive touch sensor to detect the touch of the dielectric medium.

4. The portable terminal of claim 1, wherein a first resonant frequency of the low-frequency band antenna changes to a second resonant frequency in response to an approach of a dielectric medium.

5. The portable terminal of claim 1, wherein a first resonant frequency of the high-frequency band antenna changes to a second resonant frequency in response to an approach of a dielectric medium.

6. The portable terminal of claim 2, wherein the approach of the dielectric medium comprises at least one of a contact by the dielectric medium, and being located within a reference proximity of the portable terminal.

7. The portable terminal of claim 1, wherein the first antenna unit is disposed at a first portion of the portable terminal and the second antenna unit is disposed at a second portion of the portable terminal.

8. The portable terminal of claim 1, wherein the first antenna unit comprises the second sub-antenna and the second antenna comprises the first sub-antenna.

9. The portable terminal of claim 1, wherein the second antenna unit comprises the first sub-antenna and the second sub-antenna.

10. The portable terminal of claim 1, further comprising:
a compensation controller to determine a permittivity of at least one of the low-frequency band antenna and the high-frequency band antenna, and to determine a compensation value of a resonant frequency of at least one of the low-frequency band antenna and the high-frequency band antenna that is changed, the compensation value corresponding to the permittivity.

11. A portable terminal, comprising:
a first antenna unit comprising a low-frequency band antenna to service a low-frequency band;
a second antenna unit comprising a high-frequency band antenna to service a high-frequency band,
wherein the first antenna unit is disposed at a first portion of the portable terminal and the second antenna unit is disposed at a second portion of the portable terminal.

12. The portable terminal of claim 11, wherein a resonant frequency of at least one of the low frequency band antenna and the high frequency band antenna changes from a first resonant frequency to a second resonant frequency.

13. The portable terminal of claim 12, further comprising:
a first compensation unit to compensate a second resonant frequency using a compensation value when a radio signal is serviced by the low-frequency band antenna; and
a second compensation unit to compensate the second resonant frequency using the compensation value when a radio signal is serviced by the high-frequency band antenna.

14. The portable terminal of claim 11, further comprising:
a sub-antenna unit comprising a sub-antenna to support the low-frequency band antenna during communication, and a sub-antenna to support the high-frequency band antenna during communication.

15. The portable terminal of claim 11, further comprising:
a compensation controller to determine a permittivity of at least one of the low-frequency band antenna and the high-frequency band antenna affected by an approach of a dielectric medium,
wherein the compensation controller searches a compensation table to identify the compensation value.

16. The portable terminal of claim 15, wherein the compensation table comprises a list of compensation values of a resonant frequency corresponding to a list of permittivity of at least one of the low-frequency band antenna and the high-frequency band antenna.

17. The portable terminal of claim 13, wherein the first compensation unit compensates by modifying the second resonant frequency of at least one of the low-frequency band antenna and the high-frequency band antenna to the first resonant frequency.

18. The portable terminal of claim 13, wherein the second compensation unit compensates by modifying the second resonant frequency of at least one of the low-frequency band antenna and the high-frequency band antenna to the first resonant frequency.

19. The portable terminal of claim 11, wherein the second compensation unit compensates by modifying the second resonant frequency of at least one of the low-frequency band antenna and the high-frequency band antenna to the first resonant frequency.

20. The portable terminal of claim 11, further comprising:
a first sub-antenna to support the low-frequency band antenna during communication; and
a second sub-antenna to support the high-frequency band antenna during communication.

21. The portable terminal of claim 20, wherein the first antenna unit comprises the second sub-antenna and the second antenna comprises the first sub-antenna.

22. The portable terminal of claim 20, wherein the second antenna unit comprises the first sub-antenna and the second sub-antenna.

23. The portable terminal of claim 11, further comprising:
a compensation controller to determine a permittivity of at least one of the low-frequency band antenna and the high-frequency band antenna, and to determine a compensation value of a resonant frequency of at least one of the low-frequency band antenna and the high-frequency band antenna that is changed, the compensation value corresponding to the permittivity.

24. A portable terminal, comprising:
a first antenna unit comprising a low-frequency band antenna to service a low-frequency band;
a second antenna unit comprising a high-frequency band antenna to service a high-frequency band;
a sensor to detect an approach of a dielectric medium and to determine whether a part of the first antenna unit or the second antenna unit is affected by the dielectric medium; and
a compensation controller to determine a permittivity of at least one of the low-frequency band antenna and the high-frequency band antenna affected by the dielectric medium using sensing information of the sensor, and to determine a compensation value of a resonant frequency of at least one of the low-frequency band antenna and the high-frequency band antenna that is changed in response to the dielectric medium, the compensation value corresponding to the permittivity.

25. A portable terminal, comprising:
a first antenna unit comprising a first main antenna to service a first frequency band, and a first sub antenna to service a second frequency band;
a second antenna unit comprising a second main antenna to service the second frequency band and a second sub antenna to service the first frequency band;
a communication unit to select an antenna to transmit or receive a radio signal comprising data;
a first switch unit to switch the radio signal from the first frequency band antenna to the selected antenna; and
a second switch unit to switch the radio signal from the second frequency band antenna to ii the selected antenna.

26. The portable terminal of claim 25, wherein the communication unit selects a corresponding sub-antenna to support communication of the selected antenna.

27. A method for compensating for a change in permittivity, comprising:
determining permittivity of at least one of a low-frequency band antenna and a high-frequency band antenna of a portable terminal; and
determining a compensation value of a resonant frequency of at least one of the low-frequency band antenna and the high-frequency band antenna that is changed,
wherein the compensation value corresponds to the permittivity, and the resonant frequency of at least one of the low-frequency band antenna and the high-frequency band antenna changes from a first resonant frequency to a second resonant frequency.

28. The method of claim 27, further comprising:
compensating, according to the compensation value, for the second resonant frequency of at least one of the low-frequency band antenna and the high-frequency band antenna of the portable terminal.

29. The method of claim 28, wherein the compensating comprises modifying the second resonant frequency of at least one of the low-frequency band antenna and the high-frequency band antenna to the first resonant frequency.

30. The method of claim 27, wherein change in the resonant frequency is greater for the low-frequency band antenna than the high-frequency band antenna.

31. A method for switching antennas in a portable terminal, comprising:
selecting an antenna for transmitting or receiving a radio signal comprising data;
switching the radio signal from a first frequency band antenna of a portable terminal to the selected antenna; and
switching the radio signal from a second frequency band antenna of the portable terminal to the selected antenna.

32. The method of claim 31, further comprising:
selecting a corresponding sub-antenna for supporting communication of the selected antenna.
